(19) United States
(12) Patent Application Publication
(10) Pub. No.: US 2023/0139560 A1
(43) Pub. Date: May 4, 2023

(54) PAVING MATERIAL SEGREGATION DETECTION AND MONITORING

(71) Applicant: Caterpillar Paving Products Inc., Brooklyn Park, MN (US)

(72) Inventors: Ryan T. Thiesse, Otsego, MN (US); Toby A. Frelich, Saint Michael, MN (US); Dana W. Miller, Rogers, MN (US); Rolf af Klinteberg, Kållekärr (SE); Ryan J. Nelson, Maple Grove, MN (US); Bradley D. Anderson, Rogers, MN (US)

(73) Assignee: Caterpillar Paving Products Inc., Brooklyn Park, MN (US)

(21) Appl. No.: 17/516,366

(22) Filed: Nov. 1, 2021

(51) Int. Cl. G06T 7/70; H04N 5/247; G06T 7/00; E01C 19/48; B60Q 9/00; G01J 5/00

(52) U.S. Cl. CPC G06T 7/70; H04N 5/247; G06T 7/0004; E01C 19/48; B60Q 9/00; G01J 5/00; G06T 2207/10048; G06T 2207/30108; E01C 19/1063

(57) ABSTRACT

A method and system for detecting paving material segregation in a paving material supply chain includes at least a paving material plant, a paving material haul truck, and a paver machine. The method and system further includes receiving segregation information from a plurality of cameras located in the paving material supply chain and identifying a location of segregation formation in the supply chain based on the received segregation information.

### TECHNICAL FIELD

The present disclosure relates generally to paving materials, and more particularly to detecting and monitoring segregation within paving materials.

### BACKGROUND

Particle segregation occurs in paving material when individual particles of similar size are grouped together within the paving materials. Asphalt created from segregated paving materials may create segregation within the paved asphalt. Particle segregation in paved asphalt may accelerate damage and decrease the life of the pavement. Particle segregation may occur at any point between an asphalt plant and the paving of a road. For example, when a haul truck is transferring paving material into the hopper of a paver machine, smaller and/or less dense paving materials may segregate to the bottom of the hopper below larger and/or denser paving materials. Traditionally, the paver machine operator or other paving workers must visually observe the paving material to detect particle segregation.

Chinese Patent Application No. CN 107341794 A (“the '794 application”) discloses a real-time asphalt uniformity testing method where a static color image of an asphalt mixture is processed to create a model evaluation of particle distribution through the mixture, which is then transmitted to a remote control center for evaluation. The '794 application discloses that the remote control center may then wirelessly transmit results of the evaluation to a separate computer.

The material segregation detection system and methods of this disclosure may solve one or more problems in the art. The scope of the current disclosure, however, is defined by the attached claims, and not by the ability to solve any specific problem.

### SUMMARY

A method and system for detecting paving material segregation in a paving material supply chain includes at least a paving material plant, a paving material haul truck, and a paver machine. The method and system further includes receiving segregation information from a plurality of cameras located in the paving material supply chain and identifying a location of segregation formation in the supply chain based on the received segregation information.

A method for detecting segregation in a paving material supply chain includes at least a paving material plant, a paving material haul truck, and a paver machine. The method includes receiving segregation information from a plurality of cameras located in the paving material supply chain; identifying a location of segregation formation in the supply chain based on the received segregation information; and providing a notification or alert based on the received segregation information.

A system for detecting paving material segregation in a paving material supply chain includes at least a paving material plant, a paving material haul truck, and a paver machine. The system further includes a central controller configured to receive segregation information from a plurality of cameras of the supply chain, detect segregation based at least in part on the segregation information and output at least one of segregation notice data, segregation alert signals, or remedial control signals to the supply chain based on the received segregation information.

### BRIEF DESCRIPTION OF THE DRAWINGS

FIG. 1 shows a paving material supply chain and segregation monitoring and detecting system according to aspects of the disclosure;

FIG. 2 shows a portion of the segregation monitoring and detection system on a paving material haul truck of the supply chain of FIG. 1;

FIG. 3 shows a portion of the segregation monitoring and detection system on a paver machine of the supply chain of FIG. 1;

FIG. 4 illustrates a schematic of the segregation monitoring and detection system of FIG. 1; and

FIG. 5 illustrates a method of the segregation monitoring and detection system of FIG. 4.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Moreover, in this disclosure, relative terms, such as, for example, “about,” substantially,” “generally,” and “approximately” are used to indicate a possible variation of ±10% in the stated value.

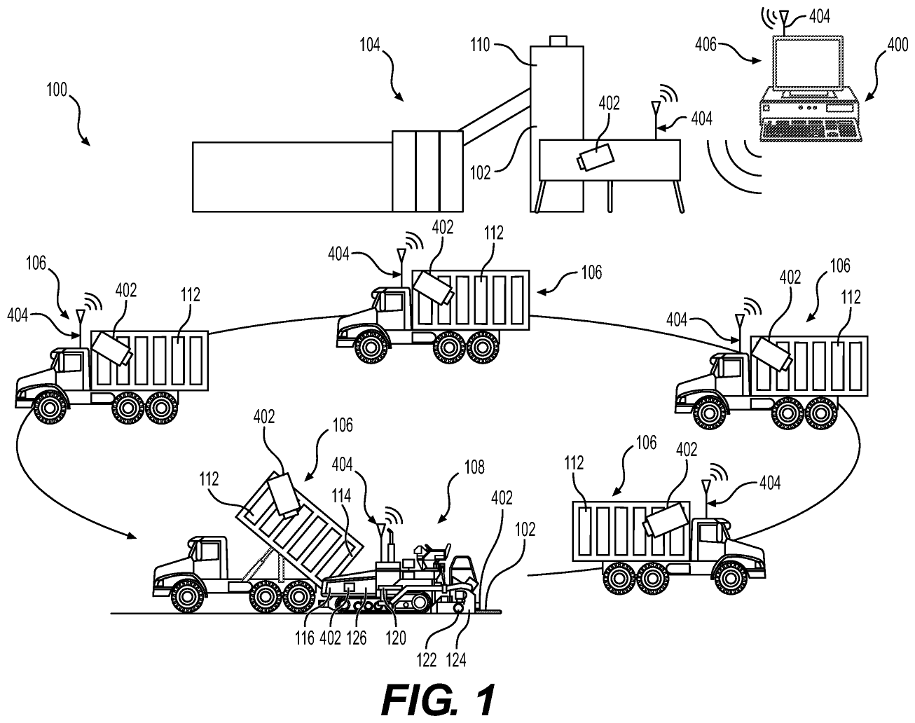

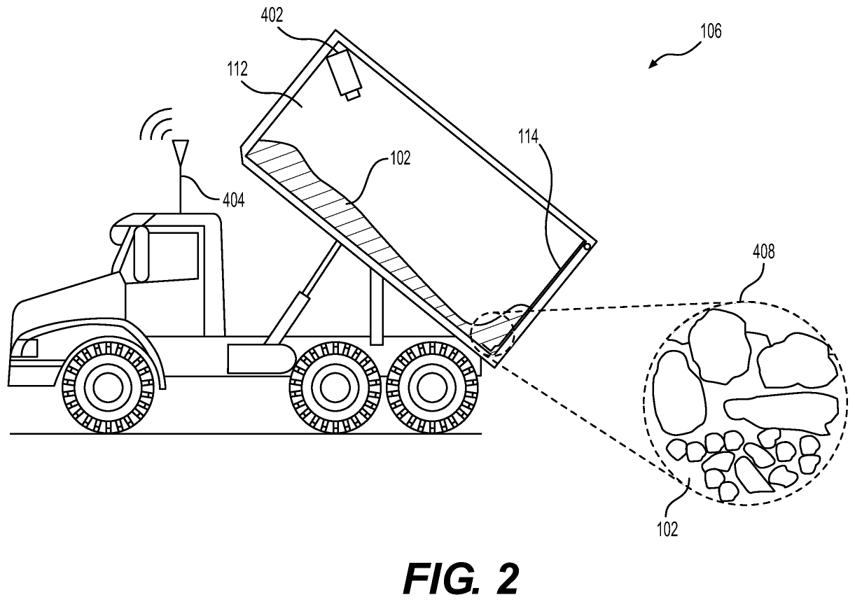

FIG. 1 shows a paving material supply chain 100 and a paving material segregation monitoring and detection system 400. As used herein, paving material will be referenced with respect to asphalt 102, however, the disclosure herein may be applicable to any type of paving material that may be subject to segregation. Segregation is a lack of homogeneity in the paving material. In particular, asphalt segregation is a lack of homogeneity in a hot asphalt mix where coarse particles, such as larger rocks or aggregates of the asphalt mix, separate from finer particles or aggregate of the mix. As shown by a camera segregation identification view 408 in FIG. 2, large rocks or aggregates may separate from smaller rocks or aggregates within the asphalt 102. The larger rocks or aggregates may be denser and/or weigh more than the smaller rocks or aggregates. As asphalt 102 moves in the supply chain 100, the smaller rocks or aggregates may migrate below and/or otherwise apart from the larger rocks or aggregates based on the movement of the asphalt 102. Thus, the larger rocks or aggregates may migrate down an asphalt pile existing within the supply chain 100. Segregation is also based on fine particles such as sand flowing through gaps in the larger rocks or aggregates. Thus, as noted above, segregation can occur at any stage of the paving material supply chain 100 and may result in a decreased lifespan of a mat of asphalt 102.

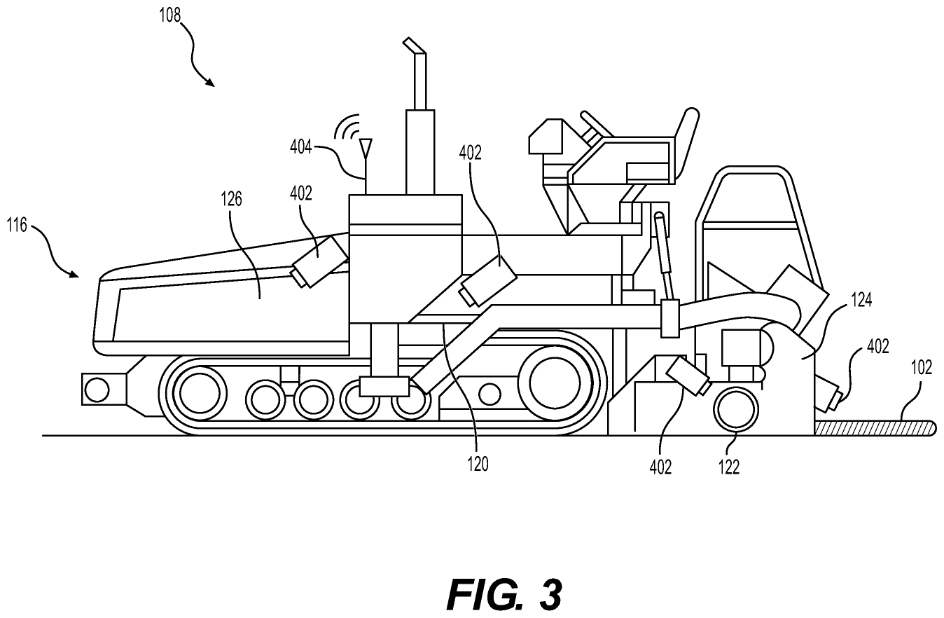

Paving material supply chain 100 may include, for example, an asphalt production and/or storage plant 104, one or more asphalt haul trucks 106, one or more paver machines 108, and a central controller 406 in communication with one or more of the plant 104, haul truck(s) 106, and paver machine(s) 108. The asphalt plant 104 may form the hot asphalt mix 102 (e.g., a mixture fine and coarse aggregates, such as sand, gravel, and rock, with bitumen) and store the asphalt in a silo 110. The one or more asphalt haul trucks 106 may be loaded with asphalt 102 from the silo 110 of the asphalt plant 104. The asphalt 102 may be received in a bed 112 of the haul truck 106. The haul truck 106 may then deliver the asphalt 102 to the one or more paver machines 108 for laying a mat of asphalt 102. In particular, the bed 112 may be raised as shown in FIGS. 1 and 2 to urge the asphalt 102 out of a tailgate 114 of the haul truck 106 into a hopper 116 of the paver machine 108. As best shown in FIG. 3, the paver machine 108 may form the mat of asphalt 102 by conveying the asphalt from the hopper 116 along a conveyor 120 to one or more augers 122, and then to a screed 124 of the paver machine 108. As will be discussed in more detail below, the hopper 116 may include side walls 126 that are actuated to fold inward to urge the asphalt 102 in the hopper 116 toward the conveyor 120. Also, the speed of the conveyor 120 and the one or more augers 122 is controllable.

Referring again to FIG. 1, the paving material segregation monitoring system 400 may include a plurality of cameras 402 for capturing segregation information, transmitters 404 for sending and receiving information within the supply chain 100 to and from a central controller or hub 406. For example, the transmitters 404 may wirelessly send segregation information from cameras 402 to central controller 406, and central controller 406 may send information (e.g., data, signals, and/or commands) to other elements within the supply chain 100. Alternatively, information exchange can be done in a wired manner.

Cameras 402 may be visible light or thermal cameras capable of distinguishing individual particles in paving material, such as the size and distribution of particles or aggregates making up the asphalt 102. For example, cameras 402 may include one or more lenses, image sensors, digitization circuitry, and image processors for converting captured images (e.g., 408, FIG. 2) to a digital format and for processing the images, for example, to detect material segregation in the images. Cameras 402 may also include memory, for example in the form of read-only memory (ROM), random access memory (RAM), integrated circuitry memory, or a combination. Cameras 402 may include communication circuitry and be wired or wirelessly connected to transmitters 404 for communicating with controller 406. Cameras 402 may include or be associated with clocks and GPS or other position sensors for identifying the time and where the images are captured.

As noted above, camera 402 may be a thermal camera configured to use, for example, Light Detection and Ranging (“Lidar”) to determine particle size and distribution within the asphalt. In such a camera 402, a laser beam is emitted, and diffraction is received by the camera 402 to determine the size and distribution of particles in the asphalt. In particular, the large particles in the asphalt may scatter light at small angles relative to the laser, and small particles may scatter light at large angles relative to the laser.

In an alternative aspect, camera 402 may be a visible light camera that captures images of the individual particles in the paving material, and that image is sent to controller for analysis to determine size and distribution of particles or aggregates making up the asphalt 102. Camera 402, either as a visible light or thermal camera, will thus sense or capture information regarding particle size and particle distribution within the asphalt 102. This information may form the segregation information sent to controller 406 for further processing and determinations regarding whether segregation exits. Alternatively, the sensed information by camera 402 may be processed within the camera 402 itself to determine whether segregation exits in asphalt 102, and such processed information may be sent to controller 406 as the segregation information.

At least one camera 402 may be positioned at each location in supply chain 100 where the asphalt will be monitored. For example, one or more cameras 402 may be located at the plant 104, the haul trucks 106, the paver machine 108, the mat of the asphalt 102, and/or any other asphalt location of the supply chain 100. In one aspect, one or more smart cameras 402 may be positioned at each of the plant 104, the haul truck(s) 106, and the paver machine(s) 108. The cameras 402 may be positioned within these elements of the supply chain 100 to appropriately view the asphalt 102 for segregation determination.

For example, one or more cameras 402 may be positioned to view the asphalt delivery to, or stored in, silo 110 of plant 104 to determine segregation at the plant 104. One or more cameras 402 may also be located on a haul truck 106, such as in the bed 112 of the haul truck 106 to view the asphalt 102 stored therein. FIG. 2 shows one such location of camera 402 to view the asphalt in the bed 112, and a corresponding camera segregation identification view 408 of the asphalt 102 in the bed 112. It is understood that more than one camera 402 may be used, and that the camera 402 associated with the haul truck bed 112 may be positioned and activated to view the receiving/moving of the asphalt into the bed 112 from the plant 104, the static mound of asphalt in the bed 112, and/or the dispensing/moving of the asphalt to the hopper 116 of the paver machine 108 from the bed 112 (as shown in FIGS. 1 and 2).

The paver machine 108 may include one or more cameras 402 to view the asphalt in the hopper 116, the asphalt on the conveyor, the asphalt at the auger 122, and/or the pad of asphalt 102 created by the paver machine 108. Similar to the haul truck cameras 402, the cameras associated with the hopper 116 of the paver machine 108 may be configured (positioned and activated) to view the receipt/moving of the asphalt in the hopper 116 from the haul truck 106, or view a static pile of asphalt in the hopper 116. The one or more cameras 402 located at the conveyor 120 may be positioned anywhere along conveyor 120 to properly view the asphalt located on the conveyor 120 for detection of segregation. Similarly, the one or more cameras 402 at the auger(s) 122 may be positioned to properly view the asphalt located at the augers(s) 122 for detection of segregation. Finally, one or more cameras 402 may be located at a rear end of the paver machine 108 to view the mat of asphalt 102 for detection of segregation. It is understood that additional or alternative cameras 402 may be included about the supply chain 100, such as a stationary camera 402 (not shown) adjacent mat of asphalt 102 for viewing the same.

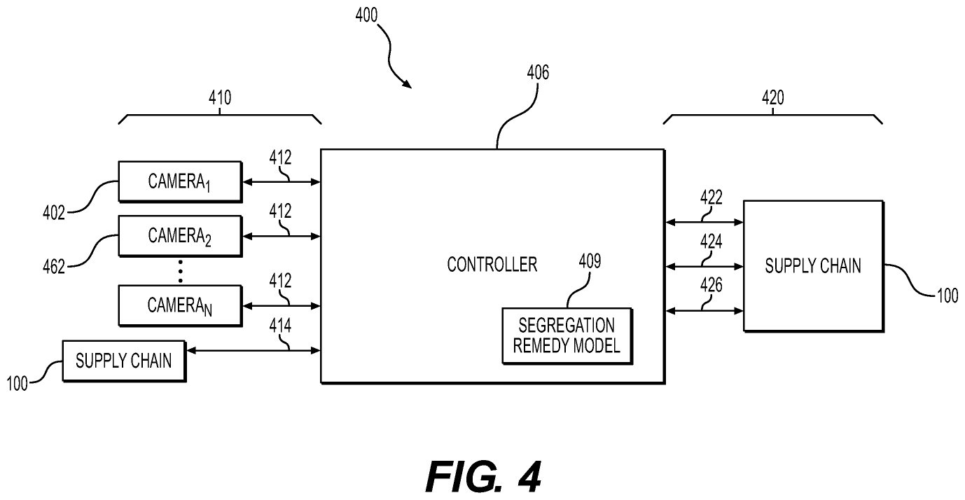

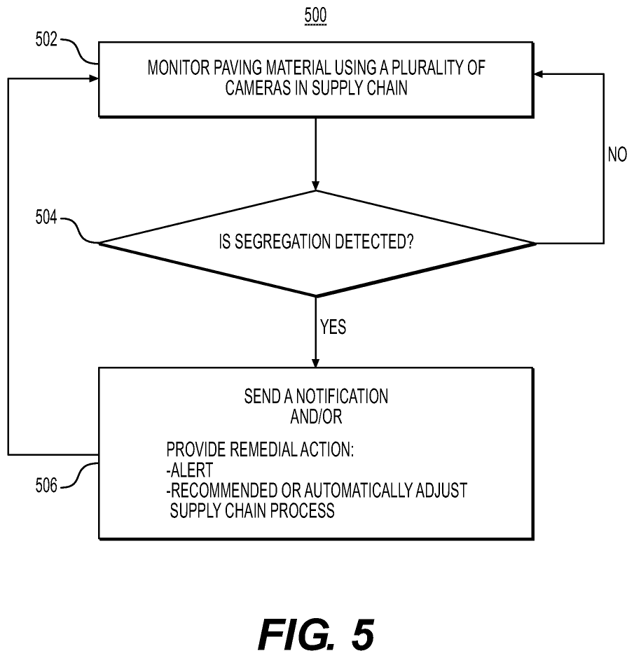

Referring to FIG. 4, the material segregation monitoring system 400 may include inputs 410 to central controller 406, and outputs 420 from central controller 406. Central controller 406 forms a part of the supply chain 100 and may be located anywhere in communication with the plant 104 haul truck(s) 106, and/or paver machines 108. For example, the central controller 406 may be located at a monitoring station remote from the other elements of the supply chain 100. Central controller 406 may embody a single microprocessor or multiple microprocessors that receive the inputs 410 and generate the outputs 420. Central controller 406 may include a memory, a secondary storage device, a processor, such as a central processing unit, and/or any other means for accomplishing a task consistent with the present disclosure. The memory or secondary storage device associated with central controller 406 may store data and software to allow central controller 406 to perform its functions including the functions described with respect to FIG. 5 and method 500 described below. Numerous commercially available microprocessors can be configured to perform the functions of central controller 406. Various other known circuits may be associated with central controller 406, including signal-conditioning circuitry, communication circuitry, and other appropriate circuitry.

The inputs 410 may include information from the one or more cameras 402. For example, cameras 402 may include (n) number of cameras providing segregation information 412 to central controller 402. As noted above, the segregation information 412 may include sensed or captured information from the cameras 402 (e.g., an image), or the sensed or captured information fully or partially processed for a segregation determination. The segregation information 412 may also include time and location information associated with the sensed information. For example, cameras 402 may include a global positioning type system and a clock for determining the location and time information of the segregation information. It is understood, however, that such time and location data may be provided by other sources than the cameras 402, such as from the plant 104, haul truck 106, and/or paver machine 108. The segregation information 412 may be provided continuously, at predetermined time or activity intervals, or upon request from central controller 406.

The inputs 410 may also include supply chain information 414 received from the supply chain 100. For example, the supply chain information 414 may include status, settings, and/or sensed or measured parameters from various elements of the supply chain 100. Such supply chain information 414 may include status, settings, and/or measured information from the asphalt plant 104, haul truck(s) 106, and paver machine(s) 108. With respect to the paver machine 108, such supply chain information 414 may include hopper data, such as status of speed of the paver machine 108, hopper actuation status and/or speed of hopper actuation, and/or speed the one or more augers 122 of the of the paver machine 108.

The outputs 420 from central controller 406 may include segregation notice information 422 sent to one or more elements of the supply chain 100. The segregation notice information 422 may include, for example, all or some of the bulk, raw segregation information 412 received from the cameras 402 at central controller 406, all or some of the processed segregation information 412 from central controller 406, and/or merely result based information indicating the existence or lack of existence of segregation in the asphalt 102, including the time and location associated thereof. The segregation notice information 422 may be provided to, for example, the asphalt plant 104, haul truck(s) 106, paver machine(s) 108, to a display associated with central controller 406, and/or to a remote location. The segregation notice information 422 may be provided continuously, at predetermined time or activity intervals, or upon request from controller 406. Further, the segregation notice information 422 may be stored, e.g. at central controller 406, for further analysis and tracking.

The outputs 420 from central controller 406 may also include remedial actions when there is a determination that segregation exists in the asphalt 102. The remedial actions may include, for example, alert signals 424 or control signals 426 sent to the supply chain 100. For example, the alert signals 424 may include a visual and/or audible alert to a display and/or speaker associated with elements of the supply chain 100. For example, the alert signal 424 may provide an alert on a display, speaker, alter light, etc. at one or more of the plant 104, haul truck 106, paver machine 108, and/or display of the central controller 406. The alert signals 424 may take the form of a mere notification of the existence of segregation and may include associated information (e.g., time and location), and/or may take the form of an alert to stop a particular process or component in the supply chain 100 in order to address the segregation.

Remedial action outputs in the form of control signals (or commands) 426 may include control signals to components of the supply chain 100 in attempts to minimize or discontinue the segregation detected. Such control signals may be signals to automatically stop particular processes in supply chain 100, or may be control signals 426 to automatically adjust processes of supply chain 100. For example, a control signal 426 may include a command to stop the paver machine 108 from paving, or the hopper 116 from actuating, or to adjust the speed of actuation of the hopper 116, or the speed of the auger(s) 122 of the paver machine 108. The adjustment may take the form of decreasing the speed of actuation of the hopper 116, or the speed of the auger(s) 122 of the paver machine 108. In another example, the remedial control signal 426 may include a new or revised route of the haul truck(s) 106 due to the determination that segregation is being caused by the current route of the haul trucks(s) 106. It is understood that such remedial control signals 426 could alternatively take the form of recommended actions to operators of elements of the supply chain 100 to address or remedy the detected segregation.

In one aspect of this disclosure, the remedial action outputs (e.g. alert signals 424 and/or control signals 426) may be determined by a segregation remedy model 409 stored within central controller 406. The segregation remedy model 409 may receive one or more of the segregation information 412, supply chain information 414, segregation determinations, results of remedial actions, weather information, and/or other information to estimate if segregation is more or less likely to occur, and then determine the most effective remedial action based on the various factors. The segregation remedial model 409 may include an optimization module receiving updated information during operation of the supply chain 100 so that the remedial action can be updated based on the additional information. This segregation remedial model 409 may be used to, for example, proactively avoid segregation by recognizing factors that lead to segregation and provide control signals or recommendations to address the factors before segregation happens or becomes more prevalent. Additionally or alternatively, the segregation remedial model 409 may use historical data to fine tune the remedial action provided or recommended to most effectively address determined segregation. Thus, the segregation remedial model 409 may assist in future supply chain planning, plant 104 operations, and haul truck 106 and paver machine 108 operations and deployment.

### INDUSTRIAL APPLICABILITY

The disclosed aspects of the present disclosure may be used in any system where paving material segregation monitoring and detection may be useful. For example, the system of the present disclosure may be used at any stage in the supply chain of the paving material, or along the entire supply chain of the paving material to help avoid the detrimental effects of segregation in the paving material.

FIG. 5 shows an exemplary flowchart 500 for the operation of the material segregation monitoring system 400. At step 502, asphalt paving material 105 is monitored by one or more cameras 402 at one or more locations of the supply chain 100. The monitoring may be achieved by central controller 406 and the segregation and supply chain information 412, 414 discussed above in connection with FIG. 4. The monitoring may include storing the segregation information 412 and segregation determinations to track the information received and determinations made at the central controller 406. Step 504 may include determining whether segregation exist within the asphalt of the supply chain 100, including where and when the segregation was formed. As noted above, this processing of sensed camera information may be partially or fully done at cameras 402 or at central controller 406. The existence of asphalt segregation may be sent and/or stored as segregation notice data 422 to elements of the supply chain 100 and/or to an offsite location (Step 506). In addition, the identification of segregation may trigger taking a remedial action. As discussed above, the remedial action of step 506 may include providing alert signals 424 to elements of the supply chain 100 (e.g., display or speakers of the plant 104, haul truck 106, the paver machine 108, and/or associated with the central controller 406) and/or to a remote location. The remedial action may also include providing control signals 426 to the supply chain 100, or recommendations for adjustments to the supply chain 100. For example, as noted above, such control signals may include commands or recommendations to stop certain actions of the supply chain 100, and/or control signals or recommendation for adjusting routes of the haul truck(s) 106, adjusting (e.g., decreasing) a speed of hopper 116 actuation, speed of an auger 122 of paver machine 108, or the driving speed of the paver machine 108.

The present disclosure may also assist in avoiding paving material segregation along various aspects of the paving material supply chain 100, or along the entire supply chain 100. In one example of the system 400, if a haul truck 106 drives over particularly uneven roads on the route to deliver asphalt 102 to a paving site, the jolting movement of the haul truck 106 may cause asphalt segregation or increased asphalt segregation that can be determined by central controller 406. Once determined, the system 400 can provide notifications, alerts, and/or recommended or actual control of the supply chain 100 to help avoid the determined segregation. For example, the system 400 can recommend or supply an alternative haul truck route, or adjustments to other processes of supply chain 100.

It will be apparent to those skilled in the art that various modifications and variations can be made to the disclosed system without departing from the scope of the disclosure. Other embodiments of the system will be apparent to those skilled in the art from consideration of the specification and practice of the material segregation detection system disclosed herein. For example, while the present disclosure describes the detection of segregation in paving material 105 in a paving supply chain 100, it is contemplated that system may be used to detect and report abnormalities in any materials monitored in a supply chain. It is intended that the specification and examples be considered as exemplary only, with a true scope of the disclosure being indicated by the following claims and their equivalents.

What is claimed is:

1. A method for detecting paving material segregation in a paving material supply chain including at least a paving material plant, a paving material haul truck, and a paver machine, comprising:
receiving segregation information from a plurality of cameras located in the paving material supply chain; and
identifying a location of segregation formation in the supply chain based on the received segregation information.

2. The method of detecting paving material segregation of claim 1, wherein the plurality of cameras are thermal cameras.

3. The method of identifying paving material segregation of claim 1, wherein the plurality of cameras provide segregation information associated with at least two of the following:
loading of paving material from the paving material plant into the haul truck;
loading of the paving material from the haul truck to the paver machine;
paving material within the paver machine; and
paving material deposited by the paver machine.

4. The method of identifying paving material segregation of claim 3, wherein the segregation information is associated with paving material within the paver machine.

5. The method of identifying paving material segregation of claim 4, wherein the segregation information is associated with paving material within a hopper of the paver machine.

6. The method of identifying paving material segregation of claim 5, wherein the segregation information is associated with paving material at an auger of the paver machine.

7. The method of identifying paving material segregation of claim 1, further including providing a remedial action in response to the identification of segregation formation.

8. The method of identifying paving material segregation of claim 7, wherein the remedial action includes displaying an alert at the paver machine.

9. The method of identifying paving material segregation of claim 7, wherein the remedial action includes sending control signals to automatically adjust a process of the supply chain.

10. The method of identifying paving material segregation of claim 9, wherein the control signals include at least one of adjusting an actuation speed of a hopper of the paver machine or adjusting an actuation speed of an auger of the paver machine.

11. The method of identifying paving material segregation of claim 7, wherein the remedial action includes sending recommendations to adjust a process of the supply chain

12. A method for detecting segregation in a paving material supply chain including at least a paving material plant, a paving material haul truck, and a paver machine, comprising:
receiving segregation information from a plurality of cameras located in the paving material supply chain;
identifying a location of segregation formation in the supply chain based on the received segregation information; and
providing a notification or alert based on the received segregation information.

13. The method of identifying paving material segregation of claim 12, wherein the plurality of cameras are thermal cameras.

14. The method of identifying paving material segregation of claim 12, wherein the plurality of cameras provide segregation information associated with at least two of the following:
loading of paving material from the paving material plant into the haul truck;
loading of the paving material from the haul truck to the paver machine;
paving material within the paver machine; and
paving material deposited by the paver machine.

15. The method of identifying paving material segregation of claim 14, wherein the segregation information is associated with paving material within a hopper of the paver machine.

16. The method of identifying paving material segregation of claim 15, wherein the segregation information is associated with paving material at an auger of the paver machine.

17. The method of identifying paving material segregation of claim 16, further including providing a remedial action to adjust a process of the supply chain in response to the identification of segregation formation.

18. A system for detecting paving material segregation in a paving material supply chain including at least a paving material plant, a paving material haul truck, and a paver machine, comprising:
a central controller configured to:
receive segregation information from a plurality of cameras of the supply chain;
detect segregation based at least in part on the segregation information; and
output at least one of segregation notice data, segregation alert signals, or remedial control signals to the supply chain based on the received segregation information.

19. The system for detecting paving material segregation of claim 18, wherein the output includes segregation notice data including a time and location of segregation in the supply chain.

20. The system for detecting paving material segregation of claim 18, wherein the output includes remedial control signals for adjusting a parameter of the paver machine.
